(19) United States
(12) Patent Application Publication
(10) Pub. No.: US 2026/0168610 A1
(43) Pub. Date: Jun. 18, 2026

(54) METHOD FOR OPERATING AN IMPLEMENT IN A PIPELINE, AND IMPLEMENT

(71) Applicant: Rosen IP AG, Stans (CH)

(72) Inventors: Ingo Nee, Dörpen (DE); Matthias Grote, Lingen (DE)

(21) Appl. No.: 19/126,679

(22) PCT Filed: Nov. 1, 2023
(86) PCT No.: PCT/EP2023/080494

§ 371 Date: May 2, 2025

(30) Foreign Application Priority Data
Nov. 2, 2022 (BE) BE2022/5891

(51) Int. Cl. F16L 55/48; G01N 27/82

(52) U.S. Cl. CPC F16L 55/48; G01N 27/82

(57) ABSTRACT

A method is provided for operating a working apparatus in a pipeline having a medium flowing in an axial direction. The untethered working apparatus is moved in the pipeline passively by the medium in a flow direction of the pipeline or is moved in the pipeline actively by a drive means. The working apparatus, which has a computing unit, records items of surroundings information in the pipeline by at least one surroundings sensor. In the computing unit of the working apparatus, the items of surroundings information are automatedly evaluated and, in the evaluation of the items of surroundings information, which are recorded surroundings sensors, at least one feature of the pipeline is identified.

### CROSS REFERENCE

This application claims priority to PCT Application No. PCT/EP2023/080494, filed Nov. 1, 2023, which itself claims priority to Belgian Patent Application No. BE 2022/5891, filed Nov. 2, 2022, the entireties of both of which are hereby incorporated by reference.

### FIELD OF THE INVENTION

The present invention relates to a method for operating an implement in a pipeline that is provided with or is to be provided with a medium flowing in an axial direction, wherein the cable-unconnected implement is moved passively in the pipeline in the flow direction of the pipeline by the medium or moves actively in the pipeline by way of a drive means, and wherein the implement, which has a computer unit, records environmental information in the pipeline using at least one, preferably using at least two environmental sensors.

### BACKGROUND OF THE INVENTION

The invention furthermore relates to an implement comprising at least one propulsion means for passively propelling the implement in a pipeline and/or at least one drive means for actively moving the cable-unconnected implement in the pipeline, and comprising at least one, preferably two environmental sensors for recording environmental information, wherein the implement has a computer unit.

The implement is in particular a (pipeline) pig and/or crawler that is wireless, that is to say without a cable connection, for example for energy transmission and communication purposes.

Implements of this type are typically used to inspect or clean pipelines in which raw materials such as oil, gas or water flow or are intended to flow. Other products moved through a pipeline may be diesel, ammonia or hydrogen. The implements are in particular moved passively through the pipelines by way of the medium flowing in the pipeline. For this purpose, the implements have what are known as cups or disks or guide plates, which fill the free inner diameter of a pipeline almost completely and thus form an obstacle for the medium. The pressure built up by the medium propels the implement forward. It is also known to move an implement through a pipeline by way of active drive means, for example when the pressure built up by the medium is not great enough or no medium is flowing in the pipeline.

An implement of this type having a computer unit is also provided with at least one environmental sensor for recording environmental information. The prior art contains a variety of environmental sensors that are able to record information from the immediate environment of the implement. By way of example, magnetic flux leakage (MFL) or eddy current (EC) sensors, optical or ultrasound-based sensors are used, in particular to identify defects in the pipeline. By way of example, IMU sensors are used to determine a pose of the implement in the pipeline or its speed.

Some methods are known from WO 2019/055546 A1. This implement has drive and propulsion means suitable, respectively, for both active movement and passive movement, and is able to actively control a desired speed, which is required for certain inspections, for example. The implement according to WO 2019/055546 A1 may have a computer unit having a CPU and means for storing data and for storing instructions.

### BRIEF SUMMARY OF THE INVENTION

The object of the present invention is to be able to use an implement in the pipeline on a more targeted basis.

A method according to the invention is distinguished in that the environmental information is evaluated automatically in the computer unit of the cable-unconnected implement and, in the evaluation of the environmental information, which is recorded in particular by way of two preferably different environmental sensors, at least one feature of the pipeline is identified and in particular correlated with a digital map of the pipeline as stored in the computer unit and/or is stored in said map. This is done while the implement is moving or travelling through the pipeline, that is to say while the implement is located in the pipeline, and in particular regardless of the speed v≥0 at which the implement is moving.

Environmental information is information that makes it possible to represent the environment of the implement. The environment in this case comprises in particular the medium, the pipeline with its possible installations and/or any electrical and/or magnetic fields present in the environment of the pipeline, for example the Earth's magnetic field. In particular, environmental information does not include any control and communication signals coming from any external and remote control unit of the implement and are transmitted to the latter with the aim of triggering an action or reaction of the implement. In particular, environmental information is information that results from technical features of the pipeline, including any installations. The technical features include, for example, weld seams, diameters and/or defects. Data from any odometer carried on the implement are not used primarily for feature recognition but rather, where applicable, only for additional position verification. An odometer may in particular be omitted.

Feature determination carried out in real time or online on the implement, and in particular with position determination carried out therewith, forms the basis for an implement that operates autonomously in a pipeline, that is able to orient itself independently in the pipeline and in particular is able to move on the basis of its own sensor information and thus on the basis of its own perception. Depending on the design of the implement, it might move only in the flow direction, or else in and counter to the flow direction. By storing hitherto unknown features in the computer unit, the implement gains an increasingly complete picture of its environment in the pipeline or of the pipeline itself, and is able to carry out any further tasks on a more targeted basis.

An implement according to the invention, comprising at least one propulsion means for passively propelling the implement in a pipeline and/or at least one drive means for actively moving the implement in the pipeline, and comprising at least one, preferably two environmental sensors for recording environmental information, wherein the implement has a computer unit having at least one computer program, is distinguished in that the computer program comprises commands, that the environmental information is evaluated automatically in the computer unit of the implement and, in the evaluation of the environmental information, which is recorded in particular by way of two different environmental sensors, at least one feature of the pipeline is identified, preferably for position determination purposes, and in particular correlated with a digital map of the pipeline as stored in the computer unit and/or is stored in said map.

According to further exemplary embodiments of the invention, the computer program comprises commands that cause the implement to carry out the further methods according to the invention that are described above or below.

An implement according to the invention may also be designed as a pig crawler and have both one or more means for passive movement and one or more means for active movement. Hereinafter, both in the description of the method according to the invention and the implement according to the invention, an implement according to the invention designed as a pig crawler will sometimes also be referred to as a pig for simplification.

The computer unit of the implement in which environmental information may be stored is configured such that the implement is able to carry out the method according to the invention or carries it out in the pipeline. The parts of the implement respectively required to carry out the method according to the invention, such as for example environmental sensors, drive or propulsion means, any further means for speed control or for fixing the implement, and any tools comprising for example sensors and/or manipulator arms, may likewise be actuated or controlled by the computer program.

Independent, autonomous recognition of a feature of the pipeline is an essential prerequisite for the implement to orient itself in the pipeline, that is to say to determine its position, for example so as to arrive at a predefined target or a target defined during the movement through the pipeline and to carry out a desired operation there. In particular, this or any other operation may be carried out repeatedly at different destinations that are present in the pipeline and that the implement is able to identify on the basis of the recognized features. Preferably, the implement is furnished with a digital map of the pipeline that is stored in the computer unit of the implement for a run through the pipeline. The feature may accordingly be correlated with a digital map stored in the computer unit during the run. If the feature is not stored in the digital map or is stored differently, the feature of the pipeline that was obtained from the environmental information may be stored in the digital map anew or additionally. The implement is thereby able for example to determine its position in the pipeline much better and to identify its position better in the pipeline. The implement according to the invention is able to perceive its environment on account of the method according to the invention, which is a basic prerequisite for autonomous action in the pipeline. Position determination based thereon enables controlled, independent action of the implement in the pipeline.

In a simple case, a digital map is a table containing waypoints or distance points and associated features. It may also be a “digital twin” of the pipeline, that is to say an effigy of the pipeline that represents the pipeline in cylinder or 3D coordinates, for example, wherein individual positions of the pipeline may be assigned certain features. The digital map may be represented by one or more data sets that may be linked to one another or may be related by a program of the computer unit.

The computer unit of the implement comprises at least one CPU or other processor unit (for example GPU, TPU or FPGA), at least one main memory, in particular in the form of a random access memory or another dynamic memory, and at least one permanent memory, for example in the form of a read-only memory or another permanent main memory, which may contain one or more databases. In addition, individual functional parts of the implement, such as sensors, an energy store, drive means or the like, may be connected via a bus system, for example. For this purpose, the implement has at least one corresponding controller. The energy store, with any battery management system, may also be considered to be part of the computer unit. Due to its computer program stored in the computer unit, the implement is configured such that it carries out the method according to the invention. This computer program may be structured in particular in a modular manner, with the result that only those modules that are respectively required to achieve a streamlined and efficient method sequence are loaded into the main memory. By way of example, the implement may switch on (computer) program modules for carrying out inspections and the associated sensors only partially or not at all while moving to an inspection target in order to save energy. The required modules are loaded into the memory, and the sensors are switched on, only when the implement has reached a position marked for this purpose in the computer unit, in particular in the digital map.

The position of the implement in the pipeline is described in particular by the position in an axial direction of the pipeline. The position may for this purpose be described by the pose of the implement in the circumferential direction. This pose is described in particular by an IMU unit of the implement. By way of example, the position may be described in meters starting from a starting point of the pipeline. The position may also be described by a segment number of a pipeline segment that is separated from other pipeline segments by transverse weld seams, which may be identified by the implement as features of the pipeline. The position may also be defined by a combination of such features.

The feature that was recognized based on the environmental sensors is stored, in particular with its position in the pipeline, in the computer unit, in particular in the digital map, such that the feature is available directly to the operating personnel without additional evaluations, including of the position in the pipeline, after the run is complete. It goes without saying that the computer unit or the implement has at least one communication interface via which, following a run, the collected environmental information or the features recognized on the basis of the environmental information may be read out, for example together with a supplemented digital map.

By way of example, magnetic sensors are used as sensors for detecting weld seams. By way of example, in the case of implements according to the invention having MFL sensors as environmental sensors, weld seams may be identified in that all MFL sensors in the circumference have a correspondingly high MFL signal in a certain time and space window. To this end, the computer program checks, directly while the implement is travelling through the pipeline, whether all functioning MFL sensors arranged in the circumferential direction about a central longitudinal axis of the implement have a signal at the same time. If so, then the computer program in the computer unit has recognized a weld seam.

The wall thickness is determined for example by eddy current sensors or ultrasound sensors. Branches or any valves may be determined for example by a camera, that is to say optically, and therefore the implement may additionally have one or more illumination means. Gyrometers or inertial measurement units (IMUs) may be used to identify rotations, accelerations and in particular curved pipeline sections.

Preferably, the position of the implement is determined continuously by way of the feature and/or further environmental information, in particular wherein, to evaluate the environmental information, data from at least two environmental sensors are recorded and the environmental information is fused on the computer unit.

The environmental information from a plurality of identical and/or different environmental sensors may be linked together via a data fusion in order to gain a higher information quality. This may be the fusion of data from a plurality of environmental sensors of the same type and/or different sensor types. On the one hand, this results in failure safety if one of the environmental sensors fails. Furthermore, an increased level of trust may be created by recognizing features in a plurality of environmental sensors independently of one another in such a way that the probability of the feature being present is higher. By way of example, the determination of the position on the basis of an odometer and an IMU (inertial measurement unit) may also lead to a redundancy of the speed measurement, which increases location determination certainty.

By way of example, while the implement is travelling, environmental sensors or sensors positioned next to one another record tracks along the pipeline, which are superimposed to form an overall picture of the pipeline. As an alternative or in addition, a forward-facing and a rearward-facing 2D or 3D camera record images of the pipeline that may be supplemented and on which features of the pipeline are characterized independently of one another, said features preferably being correlated with the digital map when the recognition is consistent. As an alternative or in addition, 3D images may be generated by combining different camera perspectives and are examined for features. Likewise as an alternative or in addition, the weaknesses of a sensor may be compensated for by a different sensor type, and so the strengths of the individual sensor types practically add up. By way of example, an IMU (inertial measurement unit) comprising an accelerometer, gyroscope and magnetometer, which are used to measure the acceleration of the sensor, angular velocity and orientation, respectively, is able to collect environmental information relatively quickly and precisely. However, said information is provided with a drift error over time, and so for example a magnetometer is used as a reference for orientation. Although a magnetometer has a lower resolution, it in return has practically no drift.

Another example of the combination of different environmental information is the use of a laser used to create a grid or line network on the inner pipeline surface, said network being recorded by a camera so as to obtain a 3D effigy. This 3D effigy may possibly be correlated with another optical camera. As an alternative, the 3D effigy may also be correlated with an acoustic camera (acoustic camera=array with ultrasonic sensors). Another example of a corresponding data fusion is the identification of bumps in the pipeline using classical geometric methods (for example EC sensors in the turbine enclosure or gaugeplate), which are then measured precisely using an optical or acoustic camera. A manipulator arm, if present, additionally measures the depth profile of the bump precisely in accordance with a mechanical feeler principle. It goes without saying that the implement is provided with appropriate environmental sensors or functional components (for example manipulator arm) to generate the appropriate environmental information.

The environmental information may be fused before or after the features have been recognized.

A feature obtained from the environmental information may be used in the computer unit in particular for location or position calibration purposes and/or for precise position determination of the implement. This allows the position of the implement to be determined more accurately by the latter, with the result that, on the one hand, the inclusion of still unknown features of the pipeline in a digital map is improved and, on the other hand, the actions of the implement that are to be carried out on the basis of the position may be carried out on a more targeted basis. In particular, an energy input of the implement for the method steps to be carried out while travelling in the pipeline is thereby able to be planned better, the implement is able to make better use of the available energy and cope with longer distances in the pipeline or use its energy on a more targeted basis by avoiding unnecessary measurements.

Advantageously, the digital map is supplemented with pipeline condition information obtained from the environmental information and/or further sensor information, for example in the form of bumps, hot taps, corrosion, defects and weld seams. Such a digital map may then be downloaded from the implement after the run through the pipeline is complete and used for other implements or for another run of the same implement, such that subsequent runs or journeys of implements are able to be carried out on a more targeted basis.

Preferably, a position-specific and/or feature-specific action is carried out by the implement. This may involve for example speed control, in which the implement reduces its speed independently depending on a distance from a target stored in the digital map and, if a certain speed is fallen below at a certain target point, triggers a certain measurement process, for example a high-resolution ultrasound scan. The computer program running in the computer unit or the computer unit itself is configured accordingly, wherein the implement according to the invention has corresponding speed control means. By way of example, the implement may have a controllable bypass and/or active drive means by way of which it is possible to control a speed of the implement.

A feature-specific action is for example switching on and using an inspection sensor depending on the feature. By way of example, hitherto unknown features, that is to say features not stored in the computer unit in a digital map, for example weld seams, which are identified in the computer unit during a passively driven journey in a pigging mode, may be approached again and inspected with a high-resolution inspection method. To approach a point to be inspected, the position of which has been identified through correlation with the digital map and/or in connection with features stored therein, the implement may have a crawler mode in which the pig moves in the pipeline via actively driven drive means. For this purpose, the pig may use these drive means for example to support itself on the inner surface of the pipeline and/or to move upstream counter to the flow of any medium that may be present. The speed of movement in crawler mode is reduced compared to a speed in pigging mode, which is characterized by passive, medium-induced propulsion by way of appropriate propulsion means (cups, disks). In crawler mode, the implement is able to move and come to a stop counter to the flow. To come to a stop and stay stopped in the pipeline, the implement may have fixing means that the implement uses to jam itself in the pipeline.

In particular, the position-specific and/or feature-specific action may be formed by a transition from one operating state to another operating state. An operating state is for example a state in which the implement is driven passively or actively. An operating state with active drive may also be described as a crawler mode. An operating state with passive drive may also be referred to as a pigging mode. Another operating state may be characterized by adopting a fixed position at a certain point in the pipeline. In addition or as an alternative, the operating states may differ through the use of different sensors or sensor controls.

Preferably, the position-specific and/or feature-specific action takes place during the same journey of the implement. As an alternative, it may also take place during a further journey of the same or another implement, in particular if the implement has no means for active movement, in particular the flow of a medium present in the pipeline. In this case, the data concerning the features to be inspected and/or the digital map are transmitted in advance to the further implement.

Preferably, reference points are represented in the digital map, for example in the form of weld seams, markers, installations or bends, and the environmental information is evaluated for the purpose of recognizing such reference points. The features of the pipeline that are recognized on the basis of the environmental information may be compared with these reference points in the computer unit, and the position of the pig or implement may be determined more precisely or a position-specific and/or implement-specific action may be triggered, which may be for example a transition from a passive to an active operating state, a measurement and/or a repair. By way of example, when a position defined by the method according to the invention is reached, a measuring device or sensor may be activated or used with a higher scanning rate to inspect a pipeline area located downstream of the recognized position in more detail.

Advantageously, a reference point stored in the digital map may also be replaced by the more up-to-date information concerning the feature recognized as a reference point. In particular, recognized reference points may be confirmed, added or, where applicable, also renamed in the digital map based on the recognized pattern. In this case, the position of the reference points in the digital map may be made more precise with each pattern recognition, which may also be done for example via statistical averaging from multiple inspection runs.

Preferably, at least some of the environmental information is classified in the computer unit, and the data derived therefrom are compared with the data of predefined patterns, in particular for feature recognition. Such a comparison may be used to recognize a feature and determine a position. By way of example, the implement may carry out a screening measurement method in the target area with a sensor, with the aim of identifying and locating defined points in the form of defect patterns, for example. Such a measurement method may initially be of a coarse resolution and may have a long range; for example, it may be a long-range UT method here. The signals picked up are then recorded and automatically analyzed by the implement in the computer unit. In this case, the classified measurement signals may be correlated with predefined classes (patterns). If a specific pattern or specific class is then recognized, the implement may carry out an instruction prescribed for such a pattern and, for example, may carry out a detailed inspection of a defect area that is possibly present using PAUT (phased array ultrasonic testing). The pattern recognition method, for example based on machine learning (ML) models, may lead to the assignment of a confidence level that determines whether or not a particular work procedure is performed. For example, in the event of an excessively low confidence level, a fine-resolution inspection may be eschewed.

A coarse-resolution measurement method may also already be performed as screening during the first operating state. If a defect area not represented in the digital map is already identified, for example, during such screening and associated pattern recognition, a rule that is stored in the computer unit may be that this area is approached and examined separately again in the second or third operating state.

Advantageously, location-dependent instructions in particular are stored in the computer unit in the digital map and/or at least in one further data set of the computer unit and are carried out by the implement upon reaching the target or upon recognizing a feature. The implement may, on the basis of the information from its environmental sensors and the recognition of its position, take any measures relevant to the position, for example based on the distance to a target, such as a speed reduction.

Generally speaking, during a passive operating state of the implement in which it moves passively through a pipeline, an in particular coarse-resolution inspection is advantageously possible, whereas, during a second operating state with active movement, screening or a closer examination may likewise be carried out. During a third operating state, during a yet further decelerated journey or a standstill of the implement in the pipeline, a detailed inspection or tool application for treating the pipeline may be carried out. In addition, during the second operating state, just like in the third operating state, any points to be examined or generally the inside of the pipe wall may be cleaned. It is also possible, depending on the design of the invention, to carry out cleaning and/or repair as well as a detailed inspection in the third operating state. To fix itself in the pipeline, the implement may include fixing means able to be actuated appropriately by the computer unit, for example outwardly expandable cups or disks or brake shoes, which may be pressed against the inner surface of the pipeline.

The implement-specific or position-specific behaviors during one of the three operating states may also change depending on the pipeline being examined and its properties. For this purpose, the computer unit may be furnished with appropriate rules and instructions in advance. By way of example, cleaning may be carried out in the event of visible soiling of the pipelines, for which a milling tool may be used for example, while a detailed inspection may be carried out at another position during the third operating state.

Advantageously, the computer unit is configured with the computer program such that the in particular location-dependent instructions are carried out on the basis of rule-based decisions represented in the computer unit. A corresponding set of rules may be designed on an implement-specific basis and may be carried out for example depending on recognized defects or defect patterns, which may be found in one or more data sets containing surroundings information or environmental information.

Advantageously, one or more work procedures, generally from a group of different work procedures that may be carried out by the implement, may be carried out simultaneously or successively on the basis of the evaluation of the environmental information, in particular wherein the implement carries out an inspection and/or pipeline repair.

For the purpose of carrying out inspections or repairs, the implement may have at least one activatable tool, which is in particular a sensor or a tool for mechanically treating the pipeline, for example a cleaning tool.

In particular, the digital map stored in the computer unit may be used during a run of the implement to screen and/or to inspect the pipeline, this being able to be carried out in particular using the position able to be read by way of the digital map and any accompanying instructions.

The implement preferably has at least one propulsion means for a passive and medium-driven operating state.

According to a further advantageous embodiment of the invention, the implement has at least one drive means for an operating state, referred to as second operating state, in the form of an active movement. This drive means may be a drive means that drives counter to or in the direction of the flow of the medium, in particular wherein at least a relative speed with respect to the medium is achieved by actuating the drive means. It may be a drive means through which the implement actively supports itself on the wall of the pipeline and moves along with respect to the latter. By way of example, they may be drive rollers, magnetic wheels and/or chain drives or caterpillar track drives using which the implement is able to move counter to the flow or else in the direction thereof. As an alternative or in addition, it may be a drive means that causes a drive by acting on the medium, for example one or more nozzles or a propeller/impeller.

To reduce the influence of the passive propulsion means, these may be transferred, in accordance with a further advantageous embodiment of the invention, from their operating position, in which they fill the inner pipeline cross section for optimum passive propulsion, to a rest position located more closely to a central longitudinal axis of the implement, at least partially by way of one or more propulsion means actuating means. This rest position is in particular one in which the implement is no longer driven sufficiently by the medium alone and in particular is no longer passively driven, since the friction between the implement and the medium is too great. The implement may brake by transferring to such a rest position.

The implement may preferably, on the basis of the digital map, head for a predefined target, or a target defined automatically while the implement is moving or travelling through the pipeline, in order to carry out a position-specific or implement-specific action there. A target is a position in the longitudinal direction of the pipeline, an area along a specific pipeline section, or a combination of the two. To reach a target, this may be defined and stored in the digital map of the pipeline that is stored in the computer unit. It may also be a target or an area of a pipeline that is recognized while the implement is moving through the pipeline and is defined as being important for further examination.

Due to the invention, an implement in the pipeline may first move passively over long distances with the flow and using only low energy resources, may then change from the operating state that is passive with respect to the movement to a further operating state characterized by an active movement in order to approach a target and may thus move in a controlled manner toward the target in order to then carry out for example a certain inspection or a repair process at the destination. This applies both to predefined targets and to targets that are defined during a journey, for example one or more areas with defects that are initially crossed by the implement, wherein environmental information regarding the defects is recorded and is then evaluated. If the areas with defects are identified as sufficiently interesting targets in the computer unit, the implement may then actively return to these areas and may carry out an implement-specific operation there, for example more detailed measurements.

Any drive means that are present for actively moving the implement may affect the position of the implement in the axial direction along the pipeline. Preferably, they may also affect the pose or orientation of the implement about its longitudinal axis in the pipeline, for example in order to rotate a (pipeline) pig, which has a certain sensor at a certain circumferential position, into the desired position about the central longitudinal axis of the pig.

The position in the longitudinal direction of the pipeline may be a length in meters, for example with reference to an origin; it may also be a position that defines a pipeline segment, for example, by a number of circumferential weld seams starting from an origin.

In one development according to the invention or in a further invention, the position may be defined by a combination of flow velocity and time. Accordingly, it is an option for a method according to the invention for the progress of the implement in the pipeline to be defined by the elapse of time and for the implement to change the operating state on the basis of the elapsed time. In one invention, such a variant may also change the operating state without, or additionally due to, the evaluation of environmental information, wherein the implement is also again equipped with active and passive drive or propulsion means and with a computer unit that ensures that the operating state is changed. In such an invention, the implement or the method may additionally have the features described above and below for control.

Referring again to the invention defined in the independent claims, the implement according to the invention may record, as environmental information, the line moved along on the inside of the pipeline, in particular using an odometer. As an alternative or in addition, there may be an environmental sensor in the form of a Hall sensor that picks up magnetic signals generated by way of one or more magnetic markers on the pipeline. As an alternative or in addition, the environmental sensor may be a micromagnetic sensor that picks up the magnetic field outside the pipeline or the magnetic field able to detected thereby in the pipeline. Whereas the environmental sensor may thus perceive in the widest case everything that is present outside the implement and around it, for one development of the invention, the at least one environmental sensor is limited to the medium located in the pipeline and/or to the features of the pipeline able to be perceived from the inside. For example, these are one or more geometry sensors, sensors for NDT methods (EC, MFL, ultrasonic sensors), or optical sensors that allow the implement to perceive the inner pipeline, its condition, and thus its environment.

By virtue of the perception of its position according to the invention, the implement is able to act on a situational basis in conjunction with propulsion means for passive propulsion and with drive means for active drive, and a broad spectrum of range and tasks is covered. Whereas inspection tasks that require little energy input are carried out in the first operating state with passive operation, an accurate inspection with correspondingly high energy input may be carried out while approaching a target and in particular during positioning at a target. For this purpose, it is advantageous for the implement according to a further embodiment of the invention to have means for generating energy from the medium, for example a generator driven by the medium.

Advantageously, the implement has positioning and/or fixing means for positioning the implement in a third operating state and for a standstill in the pipeline. These may be clamping means that are used to jam the implement in the pipeline. In addition to the active drive means, an implement according to the invention may also have fixing means that are simultaneously in the form of propulsion means and are used to fix the implement in the pipeline. By way of example, these may be cups or disks the outer diameter of which may be enlarged and which may become jammed in the pipeline as a result of enlargement of the outer diameter. In addition to conventional cups and guide plates, a bypass may also be part of the propulsion elements provided for passive operation, which bypass is opened or closed on the basis of the findings stored in the computer unit.

If the length of the segments is known, the position may also be determined in units of length. For this purpose, the lengths of the pipe segments are known in the computer unit. Depending on the distance from a target, a change to an active movement may be started in the computer unit by the computer program when a known quantity of transverse weld seams is reached, which is generally associated with a reduction in speed. Preferably, the propulsion forces are reduced for this, due to the pressure exerted on the implement by the medium, by reducing the diameter spanned by the cups or disks and/or opening a bypass. As an alternative or in addition, it is also possible to use braking means. Braking means may be means worked separately from the cups or disks or may also be formed alongside these, at least if this function does not oppose a diameter reduction.

In addition to the general differentiation between passive and active movement, the first or the second operating state may also be characterized by a sequence of different actions of the implement. By way of example, a speed may first be reduced, by opening a bypass, to a desired speed, from which caterpillar tracks or other actively actuatable drive means, which are supported with respect to the pipeline wall, become active.

In order to change from a passive movement, which may also be referred to as the pigging mode, to a mode in which the implement moves independently in the pipeline, which may also be referred to as the crawler mode, a maximum speed should not be exceeded. If the implement is moving too fast, it must first be braked to a certain maximum speed, preferably wherein the computer unit is designed and configured to initiate a braking process in good time, depending on the distance to the target and the speed. The speed may be recorded using an odometer, and corrected, if necessary, by a based on the time and distance covered on the basis of additional environmental information. Preferably, the operating state is changed on the basis of the distance of the implement from the target.

Appropriate instructions for determining the speed and/or reducing the speed may be stored in a set of rules of the computer unit and thus stored in the computer program. Such a set of rules may, as described above, be represented in the digital map in which the pipeline is represented and in which specific instructions for action for specific positions are stored. The implement is then able to use the environmental information to recognize its position, to correlate it with the digital map and to carry out the instructions stored in the corresponding position field or target field. By way of example, when a certain segment of a pipeline is reached, characterized by a number of detected weld seams, a braking process may be presented in order to arrive, from a further segment in an active movement, at a weld seam that terminates this segment and is then examined at a standstill in the third operating state.

Instead of opening a bypass in order to reduce the speed, or in addition to opening the bypass, the pig may also be braked by friction on the inner wall of the pipe, for example due to extendable or inflatable cups or disks. As soon as the maximum speed is undershot, caterpillar tracks may also extend, for example, and the pig may continue to move in crawler mode. If the target area or target is then reached, any fixing means are extended and the implement is fixed in stationary mode. In this case, the third operating state is thus one in which the pig does not continue to move relative to the pipeline. This is also the preferred third operating state. As an alternative or in addition, the third operating state may possibly also additionally be characterized by very slow movement of the pig along the pipeline, in particular at a speed of less than 0.5 m/min, for measuring purposes.

After the measurement process, the release of the fixing means and any active drive means and partial or complete closure of a bypass may transfer the device to the pigging mode again in order to continue to the next position.

Continuously determining the position of the implement means that the latter may also more easily check and respond to its own state. For example, it is possible to decide, by monitoring the available energy and using the knowledge of energy required for certain operating states, measurement or inspection processes that is stored in the computer unit, that the implement is transferred to an energy collection mode, for example, when the available energy is no longer sufficient to actively move to the target. For this purpose, the implement may have a generator unit that may be used to absorb energy from the medium due to a speed difference, for example via a propeller driven by the medium.

The third operating state comprises in particular a decelerated measurement journey and/or sticking in the pipeline. In general, the operating states differ in terms of different motion states and any associated measurement and work processes. By way of example, during a passive movement through the pipeline, inspection data may be acquired in a conventional manner, which inspection data only roughly represent the pipeline and are suitable for recognizing any features of the pipeline.

Preferably, environmental information is also recorded during the third operating state, which environmental information is, on the one hand, data useful for recognizing the environment and the associated position of the implement in the form of a pig or pig crawler, and also, as an alternative or in addition, inspection data.

In particular, the implement has at least one manipulator arm that is equipped in particular with a tool holder. Depending on the procedure specified, the implement may then automatically change the associated tools. These are contained in particular in a magazine for storing tools. This may be arranged in a section of the implement. As an alternative or in addition, one or more tools may be arranged in a tool holder present on the outside of the pig body. The manipulator arm may be designed in a manner similar to a robot arm and may work on a multi-axis basis and access the at least one tool arranged in the magazine or the holder. A tool holder may be in the form of a standardized interface that is able to operate different tools. Such an interface is used, on the one hand, to fix the tools, for example by way of a screw connection or clamping, to supply energy and to transmit data. The tools may be attached and fixed at defined locations on or in the implement, specifically in such a way that the manipulator arm is able to grip them easily. If the manipulator arm and tool are successfully connected, the tool may be released from the original storage location, in particular from the magazine, so that the manipulator arm is able to perform the desired operation with the tool.

Possible services of the implement may be, in particular, an inspection during the first motion state and screening for initially recognizing abnormalities in the second operating state, which are then inspected in the third operating state as part of a deep inspection. Furthermore, the implement may be used for cleaning and disposal of for example wax deposits, for collecting and removing unwanted parts (for example sensors, magnets), for surface treatment, for example hardening, sandblasting, for coating, spraying and for additive manufacturing methods, for filling (in) defects and/or for maintenance work, for example adjusting, bending and aligning parts in the pipeline, for example a slide, as well as for conventional manufacturing in the form of milling, drilling, gluing, welding, grinding.

As described above, the digital map represents a digital effigy of the pipeline, which may in particular contain all prominent points, whether pipe-induced (curves) or artificially added (markers). It may also contain defects that are to be examined in more detail as part of the method according to the invention. In particular, the digital map may contain target fields, that is to say positions or position areas, with instructions, wherein the instructions include the targeted switching of the operating modes, the targeted movement toward the target fields and the respective procedures to be carried out. The digital maps may furthermore contain instructions on how the implement should behave in the event of a recognized pattern (for example anomaly) or an event (for example excessively high speed).

Preferably, the digital map is updated and optimized with each run. It may be transmitted and applied to other devices or other runs, which benefit from the map with gradually improved accuracy.

According to a further embodiment of the invention, the digital map may also be transmitted wirelessly to a device that is for example stuck in the pipeline and that uses the information and instructions to free itself.

An energy generation device that is present according to one exemplary embodiment of the invention and generates energy stores said energy in particular in an energy store of the implement. This is preferably electrical energy that is stored in a rechargeable battery. In particular, an implement according to the invention is equipped with a preferably adjustable bypass so that it does not block the line flow when fixedly positioned at a location and is able to obtain energy in optimum fashion when an energy generation device is present.

### BRIEF DESCRIPTION OF THE DRAWINGS

Reference is now made more particularly to the drawings, which illustrate the best presently known mode of carrying out the invention and wherein similar reference char-acters indicate the same parts throughout the views.

FIG. 1 shows part of an exemplary embodiment of a method according to an example embodiment of the invention.

FIG. 2 shows a further part of an exemplary embodiment of a method according to an example embodiment of the invention.

FIG. 3 shows a further schematic illustration of an example embodiment of the invention in a flowchart.

FIG. 4 shows the various operating states of an implement according to an example embodiment of the invention.

FIG. 5 shows a simplified illustration of a digital map.

FIG. 6 shows a further example of a digital map stored in a computer unit.

FIG. 7 shows a further illustration of a digital map in a computer unit of an implement according to an example embodiment of the invention.

FIG. 8 shows procedures able to be performed by an implement as a function of the operating state.

FIG. 9 shows a subject according to an example embodiment of the invention.

FIG. 10 shows a further subject according to an example embodiment of the invention.

FIG. 11 shows a further subject according to an example embodiment of the invention.

FIG. 12 shows a further subject according to an example embodiment of the invention.

FIG. 13 shows a further subject according to an example embodiment of the invention.

FIG. 14 shows a flowchart of a subject according to an example embodiment of the invention.

### DETAILED DESCRIPTION OF THE INVENTION

Individual technical features of the exemplary embodiments described below may also be combined, in combination with above-described exemplary embodiments and the features of one of the independent claims and any further claims, to form subjects according to the invention. Where appropriate, at least partially functionally identical elements have been provided with identical reference numerals. Although the implements depicted in some of the following illustrations have a preferred direction, they are in particular implements that move bidirectionally in the pipeline, that is to say implements that are able to move both in and counter to the direction of a fluid flow present during operation of the pipeline.

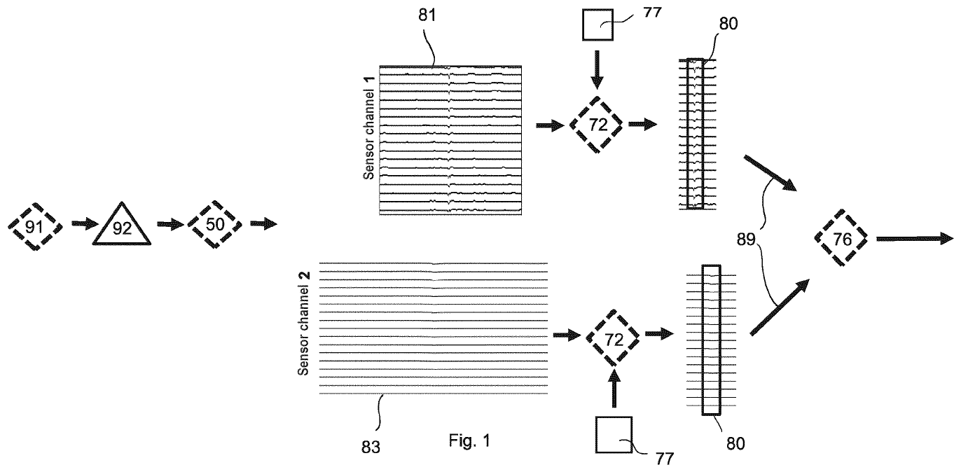

In the exemplary embodiment according to FIG. 1, for carrying out a method according to the invention, a work order 91 is first defined and states, for example, that all unknown weld seams in a pipeline should be identified and inspected. Based on this work order 91, an implement adopts an operating state I in the form of a pigging mode in step 92 and starts the inspection in this configuration. In this pigging mode, the implement is moved passively due to the flow of the medium through the pipeline. In this case, a long-range inspection 50 is started, with which data are acquired over long distances using sensors 32, 33 and/or 60. In the present case, geometry sensors arranged in the circumferential direction around a longitudinal axis of the implement, preferably based on non-contact eddy current sensors, are used to acquire lift-off data 81 in the respective sensor channel 1, illustrated here for an exemplary pipeline area. In the sensor channel 2, angle of rotation data 83, illustrated over the same pipeline area by way of example, are recorded. Both data sets 81 and 83 show the signal amplitude over time. In the exemplary data set 81 of the sensor channel 1, almost all sensors show a deflection at the same time, but only a few in the sensor channel 2. An analysis step 72 in a computer unit of the implement, which is configured appropriately, is used to carry out a real-time evaluation in which correlation with a database 77 takes place, for example by way of a numerical peak finder and with the aid of a pattern recognition algorithm, based on machine learning methods, in order to identify individual features 80 of the pipeline. In this case, a typical pattern of a circumferential weld seam is recognized with a certain probability, which is clearly based on the fact that a deflection is registered on the individual channels at the same time. In both data sets 81 and 83, the feature 80 is recognizable in the present case as a feature of the pipeline in the form of a circumferential weld seam. In a subsequent data fusion 89 of the parts of the sensor data 81 and 83 representing the feature 80, the feature 80 then results as verified in such a way that the object is assumed to be recognized in the perception step 76. Based thereon, in step 95 (FIG. 15), correlation is carried out automatically in the computer unit to determine whether the feature 80 is contained in a digital map 36 of the pipeline that is stored in the implement. If this is the case, the position of the implement results from the position assigned to the feature in the digital map.

If the feature 80 is not noted in the digital map 36, the position may for example be determined in the computer unit indirectly from a predefined length of known pipeline segments and/or from speed estimates and the time since the last known feature. As an alternative, the position may also be determined in the computer unit by correlating a signal profile of a remanent magnetic field measured during the journey with a reference signal profile of the remanent magnetic field that is stored in advance in the computer unit and is measured for the pipeline. If a position is able to be determined from the correlation of the feature with the digital map, this feature may be compared with positions determined from other methods, for example as described above, so that the position is calibrated.

If the feature was identified as a new feature during the correlation, it is stored in the digital map 36. A position-specific or feature-specific action, here carrying out an examination on circumferential weld seams identified as an unknown weld seam, may then be carried out. For this purpose, in following step 92, the operating state is changed to crawler mode II, in response to which the weld is approached in step 96. This may in particular include a movement counter to the flow of the medium.

In the case of pigs that are not able to move actively counter to the flow, the information concerning the newly identified features may be used in another journey with the same or another implement, for example in order to slow down the journey in the passively driven operating state upstream of the identified feature by opening a bypass and thus better inspect the feature.

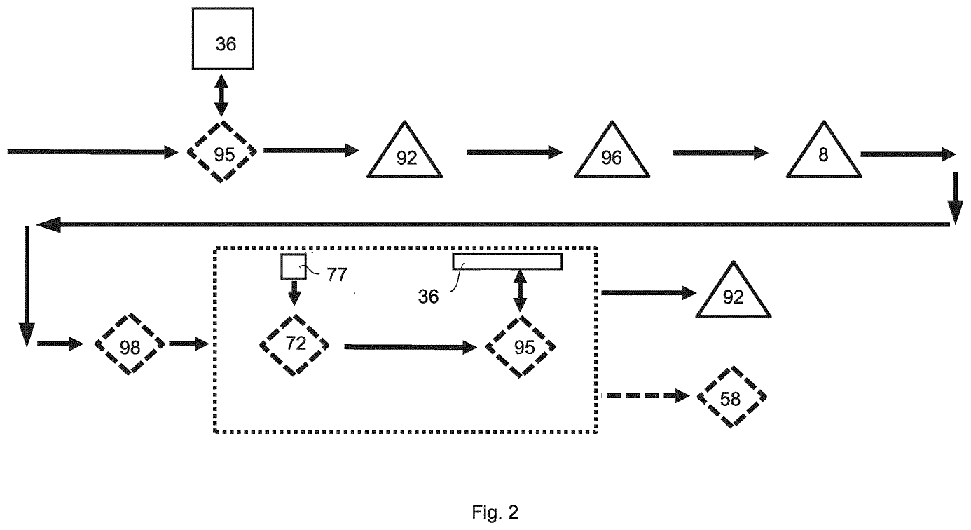

Measurement data are then produced again in a subsequent high-resolution inspection 8 and are recorded and stored in the computer unit in step 98. This may also be done in parallel with the inspection 8. In the area with a dashed border in FIG. 2, there is an optional step in which a further analysis 72 in the form of a real-time evaluation takes place in the computer unit 14 of the implement in order to check the integrity of the weld seam. In this case too, correlations with a database 77 may again be carried out. If further features, such as for example corrosion points of the weld seam, are discovered, these may in turn be stored in the digital map 36 in step 95. The inspection is then completed with the transition back to an operating state I (pigging mode) in which a long-range inspection is then started again. As an alternative or in addition, if the implement is appropriately formed with manipulators for cleaning surfaces and applying anti-corrosion materials, any repairs may also be made to the weld seam beforehand in step 58.

The field of application and the capabilities of an implement according to the invention cover a much larger range than known from the prior art. This is made possible by an implement according to the invention that records, in particular classifies, its environment in a pipeline and, on the basis of this and on the basis of the data stored in a digital map, determines a position and makes any rule-based decisions autonomously.

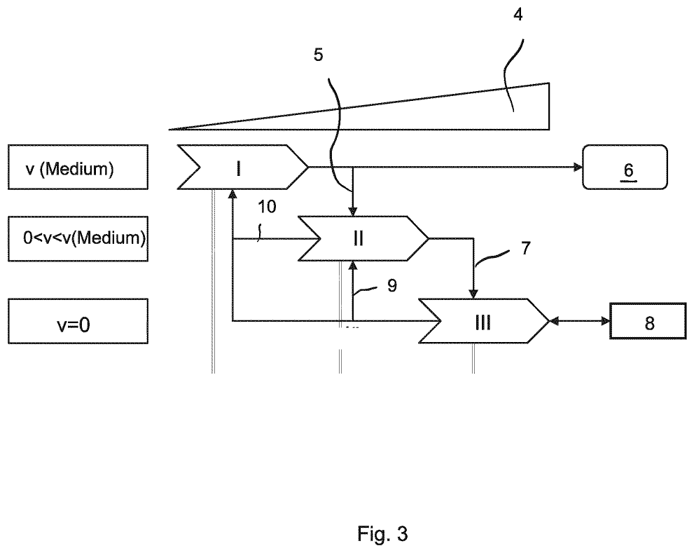

A first flowchart according to FIG. 3 additionally illustrates different operating states I, II and III for an implement according to the invention, which is designed for both passive and active drive in a pipeline and to be fixed in the pipe, and the accompanying transitions. Different speeds v are assigned to the three operating states I, II and III. In operating state I, the speed v corresponds at least approximately, in particular exactly, to the speed of the medium v(medium). In operating state II, the speed of the actively moved implement is between 0 m/s and the speed of the medium v(medium). In operating state III, the speed is v=0.

A thickening bar 4 illustrates the increasing energy requirement of the implement according to the invention from operating state I via operating state II to operating state III.

Starting from operating state I of the implement, a feature-specific action in the form of a braking process may be initiated (arrow 5), for example as a result of the environmental information-based recognition and reaching of a certain waymark, such as a certain circumferential or transverse weld seam. Such a braking process may be used to ensure that the implement approaches an outlet 6 from the line at the required speed for removal, or transitions to operating state II, in which it approaches another target defined in a digital map. When the target is reached, a further transition to operating state III may then be made, for which the implement comes to a stop (arrow 7). In this operating state, maintenance or an inspection 8 may then be carried out.

Starting from the standstill in operating state III, an active drive takes place in operating state II after releasing (arrow 9) any locking means. From operating state II, a transition to operating state I with passive drive by the medium may also take place by inactivating the active drive means and, for example, closing an existing bypass (arrow 10).

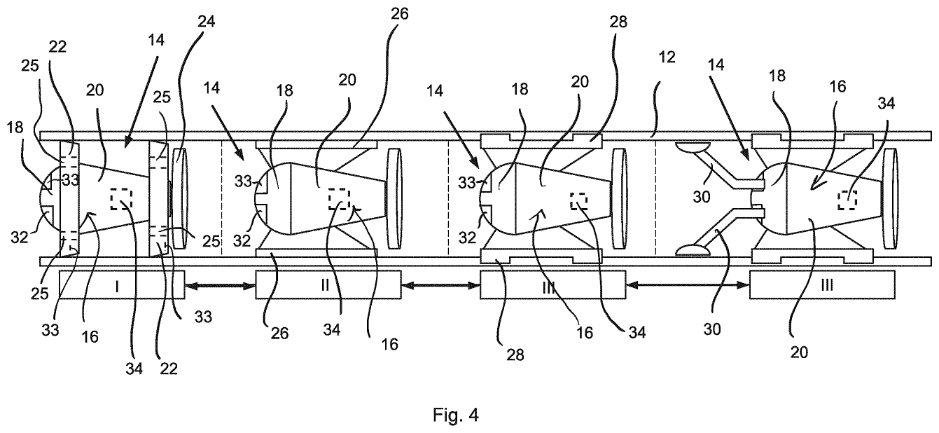

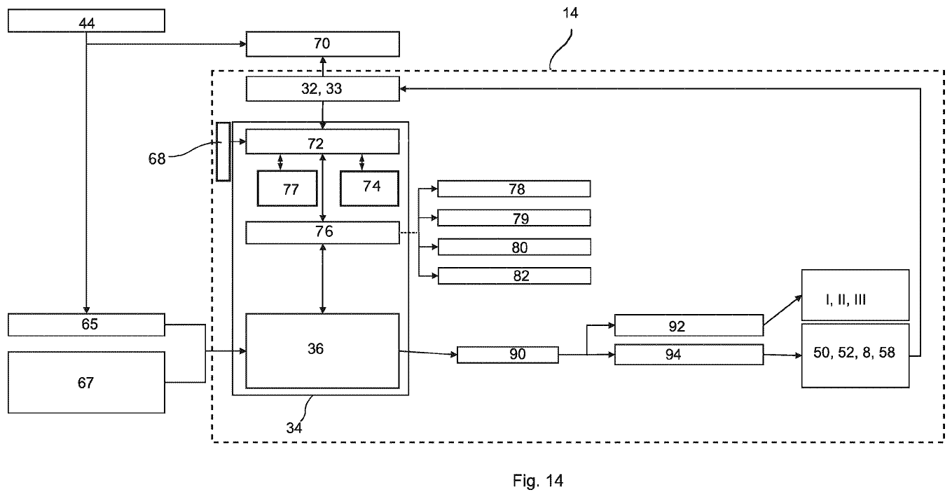

The various operating modes and possible procedures are additionally described in FIG. 14. FIG. 4 illustrates exemplary different states of an implement 14 according to the invention in a pipeline 12 in succession. A total of four different states of the implement are illustrated. For the sake of clarity, the respective illustrations of the implement do not always show all the features, but it is the same implement in each case. The individual operating states of the implement 14 are preferably adopted on a position-dependent or feature-dependent basis.

An implement 14 according to the invention is in the form of a passively driven pig in operating state I. This has a central pig body 16 that has an approximately drop-shaped form with a round head part 18 that transitions into a rearwardly tapering main part 20. The implement designed as a passively driven pig in operating state I is supported in the pipeline by way of propulsion means 22 in the form of guide plates. These may also be cups. On the end, the pig is provided with an energy generation unit comprising a propeller 24 able to be electrically driven by the medium. This drives a generator in the inside of the main part 20, in particular in operating state III described below.

In a position in which the pig is fixed in the line according to operating state III, the medium is able to flow through the propulsion means 22 and past the outside of the central body or pig body 16. In such a case, the propeller 24 may be used together with the generator to generate energy. A closable bypass with a plurality of passages 25 is formed through the propulsion means 22 and/or the pig body 16. As an alternative or in addition, the bypass may also be formed through the pig body 16 in other variants of an implement.

In operating state II, in which the bypass is open, the implement according to the invention is supported on an inner wall of the pipeline 12 via drive means 26 in the form of caterpillar tracks. The chains of the caterpillar tracks are preferably driven via electric motors. If the implement 14 has reached its target in the pipeline 12, additional fixing means 28 may be used, via which the implement 14, for example a pig or pig crawler, is secured in the pipeline. For example, these are clamping shoes that clamp the central body firmly in the pipeline 12.

In operating state III, implement-specific actions may then be performed by way of two manipulator arms 30 in the present case; for example, certain areas of the pipeline 12 may be inspected or treated by way of a mechanical tool.

The transitions between the individual operating states are made on the basis of the continuous evaluation of environmental information recorded by an environmental sensor 32. By way of example, this is an optical sensor in the form of a camera the camera image from which is examined for known patterns in a data analysis. In addition, strain gages may be arranged in the propulsion means and may record bending of the propulsion means and thus information relating to the inner diameter of the pipeline. The environmental information is evaluated in a computer unit 34 of the implement. On the basis of this environmental information and the information stored in a digital map on the computer unit 34, the implement 14 independently determines its position. In particular, the implement 14 changes its operating state on the basis of this environmental information.

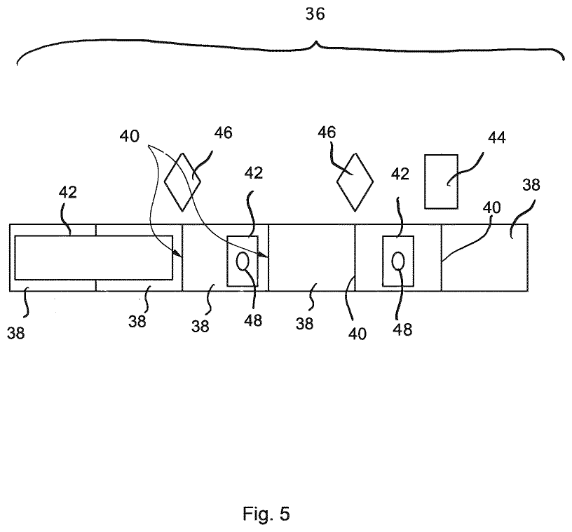

A digital map 36 of the pipeline is stored in the computer unit 34 (FIG. 5). Individual pipeline segments 38, which are arranged together via weld seams 40, are represented in this digital map 36. Individual pipeline segments 38 contain target fields 42, some of which may also be formed across pipeline segments. In addition, the digital map 36 contains information about installations 44 as well as any markers 46 in the form of magnetic markers that are fastened to the outside of the pipeline and the signal from which may be picked up within the pipeline 12. In addition, the computer unit 34 stores instructions for action on how to proceed in each case when the target fields 42 are reached.

In addition to relevant points, reference points such as weld seams 40, markers 46 and installations (for example branches or bends) are thus also stored for orientation in the digital map 36. These reference points may be known from previous runs, a pipe journal or simply from the independent addition of certain reference points by the computer unit 34 during a run of the implement 14 in certain sections of the digital map. The digital map 36 may also represent defects or areas with defects.

When travelling through a pipeline 12, the implement 14 may then determine the number of pipeline segments 38, and thus also its position, based on environmental information that makes it possible to identify weld seams 40. For this purpose, the length of the pipeline segments is stored in the computer unit. The position may be additionally correlated with the data from an odometer, for example, by way of a data fusion. This is advantageously done regularly during a run. By way of example, a weld seam is recognized by the simultaneous occurrence of a corresponding signal from all magnetic field sensors or eddy current sensors arranged in the circumferential direction around the longitudinal axis, which runs in the longitudinal direction of the pipeline, of the implement 14. If the implement 14 identifies special features such as bumps, for example, these may be added in the digital map. Depending on the identified special feature or depending on the recognized feature of the pipeline 12, this feature may be examined again on a targeted basis in operating state III.

When approaching a target field 42, the implement 14 automatically changes to operating mode II and then to operating mode III when a target field 42 to be examined at a standstill has been reached.

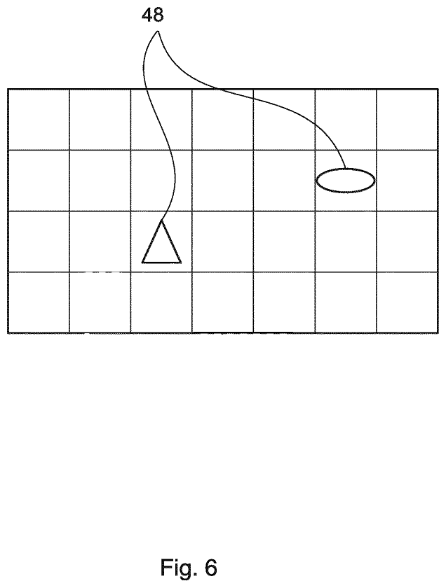

A further example of a digital map stored in the implement 14 is represented in the exemplary embodiment according to FIG. 6. In this case, the pipeline 12 is not only defined in the X direction, but also in the circumferential direction of the pipeline 12. Different reference points or defects 48 in different circumferential positions of the pipeline 12, the inner surface of which is opened up as a 2D grid, are thus localized and may also be precisely recognized accordingly in the circumferential direction by way of the alignment of the implement 14 as recognized on the basis of an inertial measurement unit, for example, and may be examined by the implement 14 on a targeted basis.

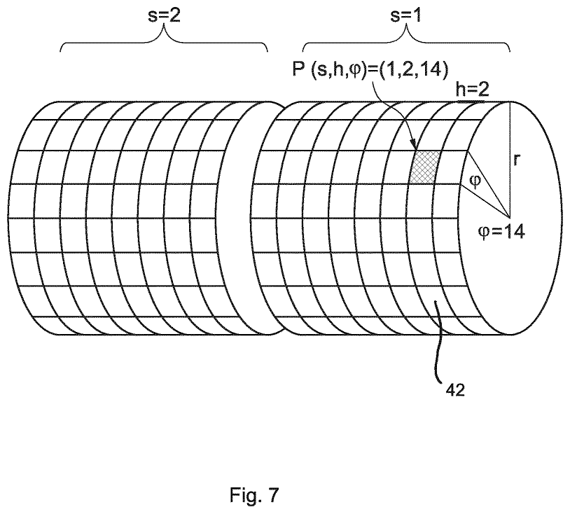

In the exemplary embodiment according to FIG. 7, the digital map 36 is stored in the computer unit 34 in the form of an effigy of the pipeline 12, which is now shown in cylinder coordinates. The possible target fields 42 are defined in the individual pipeline segments S=1 and S=2 via the segment number s, which represents the number of pipeline segments, the height in the segment and the angle φ, with the result that the target field 42 marked in FIG. 7 is defined by the position 1, 2, 14.

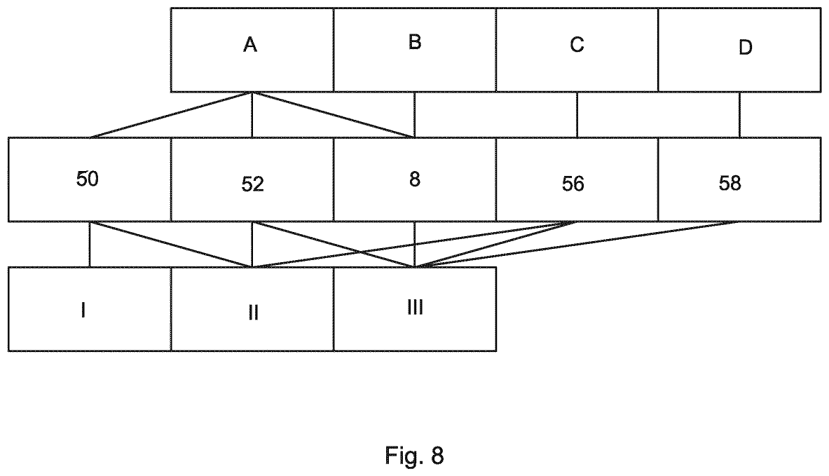

In the individual operating states I, II and III, the individual tools in the form of environmental sensors, cleaning and repair tools may be used to a different extent (FIG. 8). By way of example, tools A and B are a first sensor that may be used in operating state I for long-range or coarse-resolution inspections 50, in an operating state Il for screening 52, and in an operating state III for a detailed, fine-resolution inspection 8. A further sensor B, on the other hand, is only used during operating state III for detailed inspections 8. A tool C in the form of a rotating brush may be used for example to clean 56 the inner pipeline surface during operating states II and III, whereas a tool D in the form of a gripper arm or manipulator arm 30 is used for repair purposes only during operating state III, for example in order to move a butterfly valve of a pipeline branch.

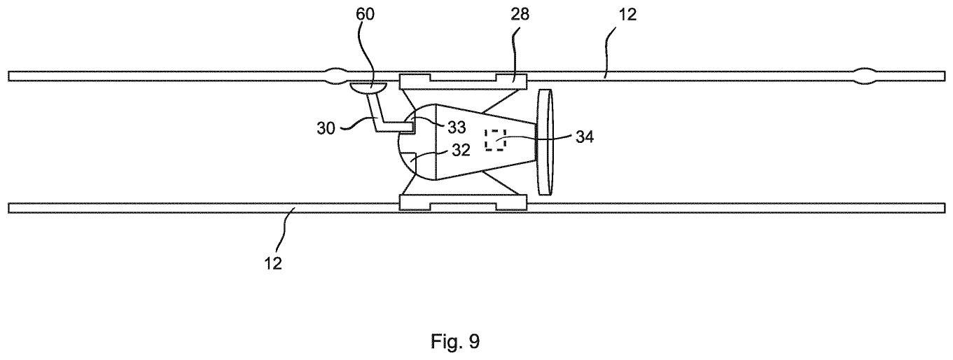

An implement according to the invention according to FIG. 9 recognizes a weld seam 40 of the pipeline 12 on the basis of the data from two different environmental sensors 32 and 33. If this weld seam is stored in the digital map as a weld seam to be inspected, or an operating instruction stipulates that all weld seams are to be inspected, this weld seam 40 is examined on a targeted basis in operating state III, in which the implement 14 is fixed in the pipeline 12 by way of the fixing means 28, using an environmental sensor 60 that is arranged on the manipulator arm or gripper arm 30. For this purpose, the sensor 60 is introduced on a targeted basis into the dead zones that are formed by the weld seam 40 and that cannot be inspected in a conventional pig run due to the sensor being lifted from the wall.

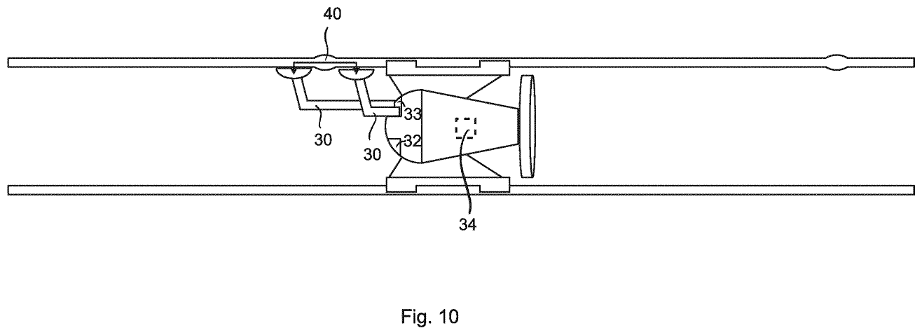

In a further exemplary embodiment of an implement 14 according to the invention, the environmental sensor is not in the form of a transmitter and receiver as in the exemplary embodiment according to FIG. 9, but rather there are two manipulator arms 30, on the ends of which a transmitter is arranged, on the one hand, and a receiver is arranged, on the other hand, wherein these manipulator arms are specifically positioned on different sides in the dead zones of the weld seam 40 to be examined (FIG. 10). These are then examined, for example, using ultrasound in the pitch and catch method. As inspection tools, the tools in this case pick up signals generated locally by the implement 14 for the purpose of recognizing the environment. Any defects recognized from this environmental information are stored as features of the pipeline in the digital map stored in the computer unit 34.

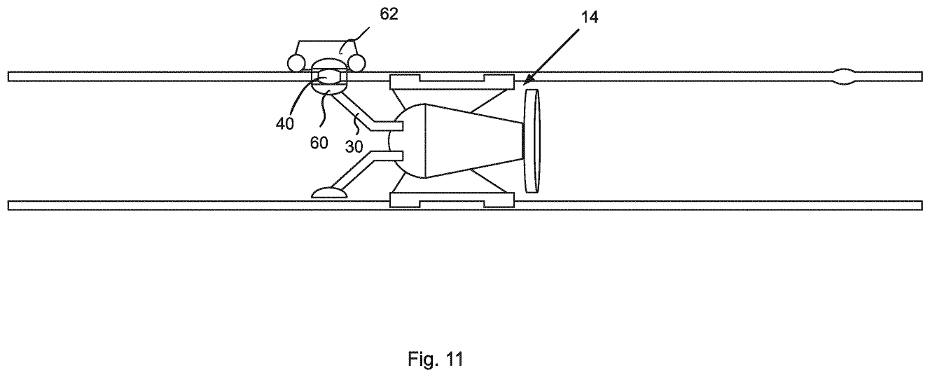

According to a further exemplary embodiment of the invention, an X-ray emitter 62 on the outside of a pipeline may be used to generate X-rays for the examination of a weld seam 40 (FIG. 11). The sensor 60 is accordingly then in the form of an X-ray receiver.

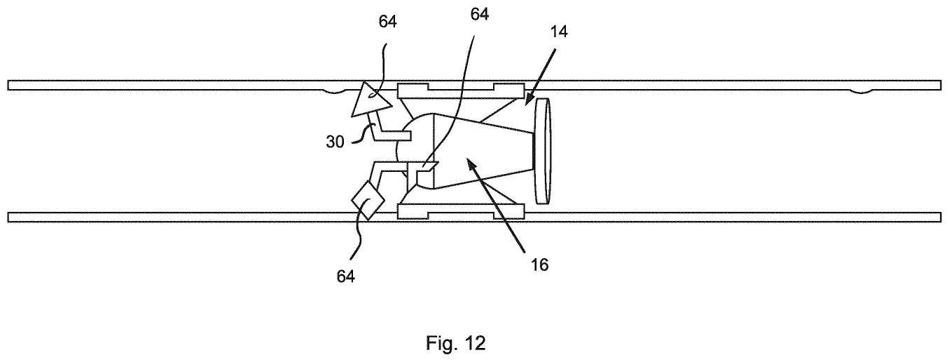

According to the exemplary embodiment in FIG. 12, an implement 14 according to the invention is provided with a plurality of tools 64 that may be fastened to the manipulator arm 30 via a corresponding interface at the end of said manipulator arm 30 and are otherwise fastened to the central body 16 and may be interchanged.

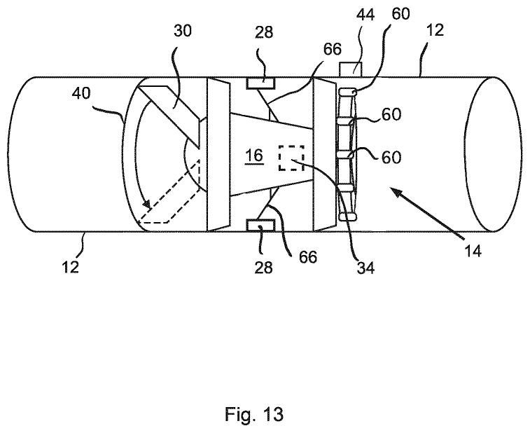

The exemplary embodiment according to FIG. 13 also again shows an implement 14 according to the invention that is fixed in the pipeline via fixing means 28. The fixing means 28 are supported on the central body 16 via extendable handlebars 66. The implement 14 is therefore in operating state III.

This operating state III is achieved for example by virtue of the fact that the implement 14 regularly correlated its position with a digital map 34 stored therein during the journey. For this purpose, for example, the pipe segments 38 may be counted during the journey in operating state I, for which purpose weld seam recognition is carried out during the journey on the basis of the recorded environmental information. After finding the correct pipe segment 38, the implement then moves on in operating state II to a certain position, for example marked by a marker 44, the characteristic magnetic field profile of which is detected by sensors 60 and is recognized with the aid of the pattern recognition performed by the computer unit 34. Subsequently, the manipulator arm 30 travels once along a weld seam 40 running in the circumferential direction with sensors that are not illustrated in any more detail, wherein this weld seam is inspected by means of ultrasound, for example. The implement 14 may then move on to a further target field 42 or may be moved on by the medium.

A slightly more detailed embodiment of a method according to the invention is illustrated in a flowchart according to FIG. 14. First, before the start of a run, the computer unit 34 of the implement 14 is provided with a digital map 36 of the pipeline 12. This digital map 36 stores line data 65 in the form of a multiplicity of features that describe the pipeline. These include for example the number of weld seams, the pipeline segments and their shape (straight, bent). In addition, orders 67 are stored in the digital map and are defined for example by target fields, that is to say targets to be headed for, actions to be performed there and tools required for this purpose. Furthermore, rules regarding how the implement 14 has to behave in the case of certain results of the analysis may be stored in the digital map 36 or in another database 77 in the computer unit 34. For example, these may be instructions to save newly recognized features or to start a safe return to the removal location.

A marker 44 externally applied to the pipeline 12 may also be represented in the line data and thus also represents an environment feature 70 that is able to be perceived via the external sensors or environmental sensors 32, 33 of the implement 14. In addition, data obtained from a sensor 60 may be used depending on the exemplary embodiment. The environment features are analyzed in the form of environmental information from the sensors 32, 33 in the computer unit 34 in step 72 for the purposes of feature recognition. The analysis 72 may also incorporate information from internal sensors 68, which for example monitor the energy balance of the implement 14. The analysis 72 also incorporates information from a database 77. For the analysis 72 of the available data, it is possible to resort to one or more computer program modules 74 that are designed for rule-based recognition, for model-based recognition or for recognition on the basis of machine learning. This results in an insight or perception 76 according to which the implement 14 knows for example its safe state 78 (for example sufficient energy supply) and its orientation 79, comprising position, speed and pose in the pipeline. Furthermore, there is a perception 76 with respect to features 80 of the pipeline, for example comprising its size and type including defects as well as the quality and grade (collectively “82”) of the individual insights.

This perception results in an action 90 that leads, for example, to adoption 92 of an operating state I, II or III and/or the performance of an in particular feature-dependent or position-dependent work procedure 94. The latter includes a long-range inspection 50, screening 52, for example in operating state II, a high-resolution inspection in operating state III and a repair 58. The features that are not yet present in the digital map 36 may also be stored therein. As an alternative or in addition, an inner coating may also be reapplied, for example.

1. A method for operating a cable-unconnected implement in a pipeline, the pipeline being provided with or to be provided with a medium flowing in an axial direction, the method comprising the steps of:
allowing the cable-unconnected implement to be moved in the pipeline in the flow direction of the pipeline passively by the medium or actively in the pipeline by a drive means;
recording, via a computer unit of the cable-unconnected implement, environmental information in the pipeline using at least one environmental sensor;
evaluating the environmental information automatically in the computer unit of the cable-unconnected implement and, in the evaluation of the environmental information, identifying at least one feature of the pipeline and/or is stored in a map.

2. The method as claimed in claim 1, wherein a position of the implement is determined continuously in the computer unit.

3. The method as claimed in claim 1, wherein the feature is used in the computer unit for position calibration purposes.

4. The method as claimed in claim 1, wherein a position-specific and/or feature-specific action is carried out by the implement on the basis of a position recognized in the computer unit.

5. The method as claimed in claim 1, wherein the feature with its position in the pipeline is stored in the computer unit.

6. The method as claimed in claim 1, wherein reference points are represented in the digital map, and the environmental information is evaluated for the purpose of recognizing reference points.

7. The method as claimed in claim 1, wherein at least some of the environmental information is classified in the computer unit, and data derived therefrom are compared with data of predefined pattern classes.

8. The method as claimed in claim 1, wherein location-dependent instructions are stored and are carried out by the implement upon reaching the target or upon recognizing a feature.

9. The method as claimed in claim 8, wherein the instructions are carried out on the basis of rule-based decisions represented in the computer unit.

10. The method as claimed in claim 1, wherein a digital map is used by the implement to screen and/or to inspect the pipeline.

11. The method as claimed in claim 1, wherein the implement carries out screening and/or an inspection of the pipeline in at least one of multiple operating states.

12. The method as claimed in claim 1, wherein one or more work procedures from a group of different work procedures are carried out on the basis of the evaluation of the environmental information.

13. The method as claimed in claim 1, wherein the implement, on the basis of a digital map, heads for a predefined target, or a target defined automatically during the journey.

14. The method as claimed in claim 1, wherein energy is generated by way of an energy generation device.

15. The method as claimed in claim 1, wherein a reference point of the digital map is replaced by the feature in the computer unit.

16. The method as claimed in claim 1, wherein the implement moves in or counter to the direction of the flow by way of at least one actively driven drive means.

17. An implement, comprising:
at least one propulsion means for passively propelling the implement in a pipeline and/or at least one drive means for actively moving the implement in the pipeline;
at least one environmental sensor for recording environmental information;
a computer unit having at least one computer program, the computer program comprises commands that have the effect that the environmental information is evaluated automatically in the computer unit and, in the evaluation of the environmental information at least one feature of the pipeline is identified.

18. (canceled)

19. The method as claimed in claim 1, wherein the environmental information is recorded by way of two different environmental sensors.

20. The method as claimed in claim 1, wherein the at least one feature of the pipeline is identified, for position determination purposes.

21. The method as claimed in claim 1, wherein the at least one feature of the pipeline is correlated with the digital map of the pipeline as stored in the computer unit.

22. The method as claimed in claim 2, wherein for the evaluation of the environmental information, data from at least two environmental sensors are recorded and the environmental information is fused on the computer unit.

23. The method as claimed in claim 8, wherein location-dependent instructions are stored in the digital map and/or in at least one further data set of the computer unit.

24. The method as claimed in claim 12, wherein the implement carries out maintenance of the pipeline and/or pipeline repair.
